(19) United States
(12) Patent Application Publication
(10) Pub. No.: US 2010/0017286 A1
(43) Pub. Date: Jan. 21, 2010

(54) Marketing Performance Model and Management Platform

(75) Inventors: Margaret Coles, San Francisco, CA (US); Scott McKinley, Mill Valley, CA (US); Haren Ghosh, Fremont, CA (US)

Correspondence Address: FENWICK & WEST LLP, SILICON VALLEY CENTER, 801 CALIFORNIA STREET, MOUNTAIN VIEW, CA, 94041, US

(73) Assignee: Factor TG, Inc., San Francisco, CA (US)

(21) Appl. No.: 12/497,432

(22) Filed: Jul. 2, 2009

Related U.S. Application Data
(60) Provisional application No. 61/079,438, filed on Jul. 10, 2008.

(51) Int. Cl. G06Q 10/00; G06Q 30/00

(52) U.S. Cl. 705/14.43; 705/14.45; 705/14.44

(57) ABSTRACT

A marketing analysis system analyzes individual and joint media effects of marketing in various media by combining multiple distinct streams of data, such as transaction, survey, and media exposure data. As a result of the analysis, the effects of various activities in various media outlet types are quantified with respect to its influence on a measure of marketing effectiveness, such as total sales for a brand, or various brand metrics such as brand awareness. Based on the quantified effects on the measure of marketing effectiveness, additional information, such as resource allocation across different media outlets, may further be determined.

### CROSS-REFERENCE TO RELATED APPLICATION

This application claims the benefit of U.S. Provisional Application No. 61/079,438, filed Jul. 10, 2008, which is incorporated by reference herein.

### BACKGROUND

The present invention generally relates to the field of sales and advertising, and more specifically, to ways of effectively allocating an advertising budget among a set of media outlets.

Advertisers annually spend billions of dollars in multiple traditional and nontraditional media outlets, such as television, newspapers, radio, Internet advertising, and the like, to influence consumer purchase decisions regarding the products and services sold by the advertisers or by their clients. Deciding which of these various media outlets to choose when advertising in order to maximize return on investment (ROI), and what portion of the advertising budget to allocate to each outlet, proves difficult. Traditionally, advertisers use a standard technique, known as Marketing Mix Modeling, to estimate the relative effectiveness of each medium. The traditional Marketing Mix Models are additive in nature, based on the assumption that revenue generated as a result of advertising spending in one outlet has no effect on that generated by spending in another outlet. That is, traditional models assume that revenue from the various possible media outlets is independent of revenue from other outlets. Other approaches, such as ROMI (Return on Marketing Investment), likewise are additive in nature.

However, the assumptions of the additive model fail to model the real world properly. For instance, advertising in a given media outlet may well influence the effectiveness of advertising in other outlets. In one scenario, for example, a heavy amount of spending on television advertising might render newspaper advertising much less effective than it otherwise would have been. In an extreme case, too much spending in one media outlet might cause exposure to the advertisement message to reach saturation point, frustrating audiences to the point that further advertising in another media outlet could actually prove detrimental, thus decreasing net revenue.

There are several other shortcomings of traditional techniques. For example, traditional models use a single stream of data to estimate the media effectiveness. For example, they use either historical sales and spending data (e.g., transaction data) or media reach and frequency data, to the exclusion of other types. Traditional models also completely ignore the influence of media-specific advertisements, or “creatives,” in performing media analysis. This may seriously undermine the estimation of media resource allocation. Finally, traditional models assume that all customer segments (e.g., young vs. old, new vs. loyal) will be affected similarly, i.e. that the market place is homogeneous in nature.

### SUMMARY

In embodiments of the invention, individual and joint media effects of marketing in various media are analyzed by combining multiple distinct streams of data, such as transaction, survey, and media exposure data. As a result of the analysis, the effects of various activities in various media outlet types are quantified with respect to its influence on a measure of marketing effectiveness, such as total sales for a brand, or various brand metrics such as brand awareness. Based on the quantified effects on the measure of marketing effectiveness, additional information, such as resource allocation across different media outlets, may further be determined.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF DRAWINGS

FIG. 1 is a block diagram illustrating a system architecture useful in conjunction with the method described herein, according to one embodiment.

FIG. 2 is a conceptual illustration of the input accepted and output produced by the marketing analysis module 116, according to one embodiment.

FIG. 3 is a high-level block diagram illustrating a detailed view of the marketing analysis module of FIG. 1, according to one embodiment.

FIG. 4 is a flowchart illustrating steps performed by the marketing analysis module in determining measures of marketing effectiveness, according to one embodiment.

### DETAILED DESCRIPTION

### Overview

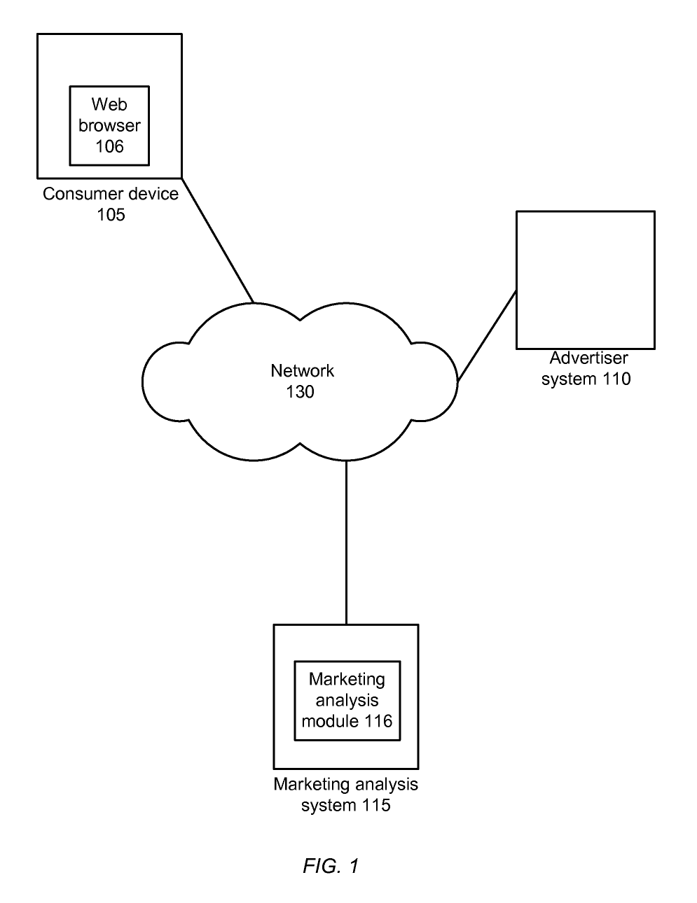

FIG. 1 illustrates one embodiment of a system architecture in which the activities described herein take place. As illustrated, consumer device 105 contains software, such as a web browser 106. The consumer device 105 could be, for example, a conventional personal computer such as a desktop or laptop computer, a PDA, a mobile phone, or other electronic device capable of carrying out data communications.

Consumers may use the web browser 106 or other network-based programs on the consumer device 105 to complete surveys regarding their opinions on various key brand metrics. These brand metrics may include, for example, awareness of the brand, opinion of the brand, intent to purchase products or services associated with the brand, and the like. These surveys may be, for example, web-based forms that are displayed in response to the user browsing a web page having an association with the brand. For instance, the surveys could be provided directly by an advertiser in response to the web browser 106 requesting a page of the advertiser's web site. Alternatively, the web browser 106 may request a web page containing content related to the brand, and code on the web page could cause a third party advertising or survey publisher to display the surveys. One of skill in the relevant art would appreciate that surveys could be provided in many different manners.

Marketing analysis system 115 receives and stores various types of input data about brands, such as survey data regarding the brands, sales data for products and services associated with the brands, data on brand advertising media spending, media reach data, and media frequency data, as more fully described below. In one embodiment, the marketing analysis system 115 has a marketing analysis module 116 that aggregates and processes the input data, performing mathematical modeling techniques to determine the effect of a particular type of media on a measure of marketing effectiveness, e.g., total sales for a brand. The marketing analysis module 116 may also estimate the optimal allocation of advertising funds to each of the possible media outlets, such as television or Internet advertising

In one embodiment, the marketing analysis system 115 is implemented using a conventional computer system, such as a server system. Although it is depicted in FIG. 1 as a single conceptual unit, it may be implemented using multiple physical components. For example, the marketing analysis system 115 could comprise one computer storage system for storing all the input data, a separate computer system that obtains data from the storage system (e.g., over a local area network) and processes the data and estimates an optimal resource allocation, and a web server that accepts input data and that provides the estimated optimal resource allocation information to clients.

Advertising system 110 comprises a computer system of an advertiser that uses the marketing analysis system 115 to obtain resource allocation information. The advertising system 110 may be used to provide the marketing analysis system 115 with input data, such as sales data for products and services associated with its brands. The advertising system 110 may also request output, such as the resource allocation information, from the marketing analysis system 115. This request may be made by using an application programming interface (API) of the marketing analysis system, such as a web service.

Network 130 represents the communication pathways between the consumer device 105, the marketing analysis system 115, and the advertiser system 110. In one embodiment, the network 130 is the Internet. The network 130 may use dedicated or private communications links that are not necessarily part of the Internet. In one embodiment, the network 130 uses standard communications technologies and/or protocols such as Ethernet, 802.11, or other appropriate technology. Similarly, the networking protocols used on the network 130 can include the transmission control protocol/Internet protocol (TCP/IP), the hypertext transport protocol (HTTP), the file transfer protocol (FTP), or other suitable protocol. The data exchanged over the network 130 can be represented using technologies and/or formats including the hypertext markup language (HTML), the extensible markup language (XML), etc. In addition, all or some of links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

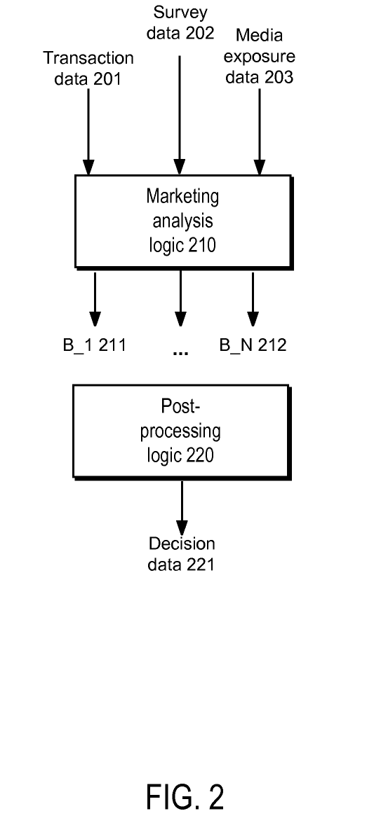

FIG. 2 is a conceptual illustration of the data flow within the marketing analysis module 116 of FIG. 1, according to one embodiment. At a high level, the marketing analysis module 116 quantifies the effects of given activities in a media outlet type on a measure of marketing effectiveness. For example, the marketing analysis module 116 may quantify the effect of television advertising on brand awareness. The marketing analysis module 116 may further perform post-processing on the quantified effects data to derive additional decision data 221. For example, the marketing analysis module 116 might derive an optimal spending allocation for advertising in each of a number of different media outlet types based on the quantified effectiveness of each of the media outlet types in affecting brand awareness.

Examples of measures of marketing effectiveness for which an effect of activities in a media type can be quantified may include total sales for a brand or various brand metrics, such as awareness (consumer's knowledge of brand existence), favorability (a consumer's respect for and appreciation of a brand even if the brand has not been or is not being consumed), consideration (a consumer's consideration of a particular brand at the time of their next purchase), among others. Other brand metrics might include communication, persuasion, and conversion.

Marketing analysis logic 210 of the marketing analysis module 116 is programmed to accept a number of distinct types of input data. For example, in the depicted embodiment, the marketing analysis logic accepts transaction data 201, survey data 202, and media exposure data 203.

The transaction data 201 may include information such as total sales to consumers for products and services associated with a brand in a given medium. In one embodiment, this sales data is organized with respect to time periods, such as weekly or monthly sales figures. Sales data can be provided by the advertiser regarding the advertiser's own products and services, or by a third party that tracks sales figures for a given industry, for example.

The survey data 202 may include attitudinal data, such as that derived from the web-based surveys described above with respect to FIG. 1. The survey data 202 may also originate from other sources, such as physically-administered surveys that were subsequently converted into digital form and uploaded to the marketing analysis system 115.

The media exposure data 203 represents data such as media reach and media frequency. Media reach is a measure of an amount of the audience that has been exposed to the advertising. One example of media reach data might state that the “Wave” brand soda television advertisements reached 50,000 viewers during the week of Jul. 7, 2008. Media frequency is a measure of an amount of brand exposure, such as the rate at which the audience is exposed to the media over a given period of time, or a total number of times that the media has been presented on a particular media outlet type. One example of media frequency data might state that there were 1000 ad impressions (renderings of the ad on a given site) per day during a given time period.

The transaction data 201 and media exposure data 203 may be obtained from various sources, such as offline consumer intercept data, retail point-of-sale data, Nielsen ratings for offline media, consumer financial data, and behavioral data from digital media such as IPTV, mobile devices, and video game consoles. A still further type of input data is frequency data, which measures the rate at which the audience is exposed to the media over a given period of time. Both media reach and frequency data can be provided by the advertiser itself, or by a third party that tracks such statistics.

Other types of media input data other than data 201-203 can also be used. For example, another type of input that may be used is data concerning brand advertising media spending. For example, one unit of this type of information might state that a given advertiser spent $150,000 on advertising in the television media outlet related to “Wave” brand soda during the week of Jul. 7, 2008. The brand advertising media spending may be provided by the advertiser, which knows the precise amount spent.

The marketing analysis logic 210 then produces as output a set of values, conceptually represented as values B_1 211 through B_N 212, quantifying the effect of actions in a particular advertising outlet, such as producing television advertisements, on a particular measure of marketing effectiveness. The particular measures of marketing effectiveness with respect to which the values are determined, e.g., a brand metric such as brand awareness, need not be the same in all analyses conducted. For example, the set of metrics evaluated may be tailored to the interests of a particular advertiser. In one embodiment, the output values (known as “impact values”) are coefficients determined as part of regression analysis. Each coefficient is associated with an independent variable, which represents a value related to a particular media type, in a linear equation where the measure of marketing effectiveness is the dependent variable.

The output values may further be given as input to post-processing logic 220, which may additionally derive further decision data 221. For example, based on the calculated brand metrics values, the post-processing logic 220 may estimate an optimal allocation of advertising resources across the various possible media outlets, further taking into account costs of advertising in the media outlets, in addition to the effectiveness thereof.

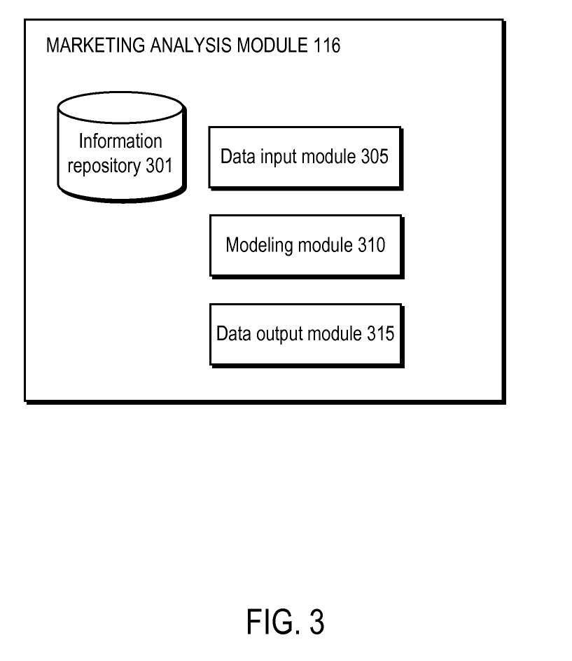

FIG. 3 is a high-level block diagram illustrating a detailed view of the marketing analysis module 116 of FIG. 1, according to one embodiment. The marketing analysis module 116 implements the marketing analysis logic 210 of FIG. 2 and includes a data input module 305 that receives the various types of input data about brands described above. The marketing analysis module 116 also includes an information repository 301, which stores the input data that are received by the data input module 305. In one embodiment, the information repository 301 is implemented using a conventional relational database management system; however, it may be implemented differently in different embodiments, such as with file system-level files.

The marketing analysis module 116 further comprises a modeling module 310, which applies mathematical modeling techniques to the brand-related data stored in the information repository 301 to derive information such as an estimate of an optimal resource allocation and an estimate of the effect of a particular type of media on a measure of marketing effectiveness.

In one embodiment, regression analysis techniques are used to determine the effect of a given activity in a given media outlet type, e.g., spending on television advertisements, on the various measures of marketing effectiveness, e.g. brand metrics such as brand awareness, total sales for the brand, and the like. The input data may be represented as equations describing the various measures of marketing effectiveness as functions of various activities in given media outlet types. The solution to the equations of the regression analysis comprises a set of coefficients (referred to herein as “impact values”) that quantify the strength of the effect that a given activity has on a particular measure of marketing effectiveness.

The following equations and associated descriptions are the mathematical representation of the aforementioned processes and, when used either singularly or in combination, produce marketing performance metrics and optimizations.

In one embodiment, the relationship among individual brand metrics, summated brand metrics, sales, and the effectiveness of various media can be integrated by the following equation,

$${Y}_{t} = {e}^{( {α}_{0} + ɛ )} {\prod }_{t = 1}^{T} {f ( {X}_{t} , {X}_{t - 1} )}^{β} \qquad ( 1 )$$

where:
α₀=The marketing effectiveness;
Xₜ=└Xⱼₜ┘=the survey respondents' evaluation of advertising on media outlet type j at time t. (This involves ad awareness variables, which are categorical variables specifying the media outlet type of the advertisement, such as TV, print, and Internet, and media-specific creative attribute variables, which are 5-point continuous scale variables dependent on the ad awareness variables and representing subjective user characterizations of a particular advertisement in a particular media outlet type. For example, some media-specific creative attribute variables are “Worth remembering”, “Effective”, “Not pointless”, “Not easy to forget”, “True to life”, “Believable”, “Convincing”, “Informative”, “Lively”, “Fast-moving”, “Appealing”, and “Well done.” A factor analytic approach is used to identify a representative factor of all the media-specific creative attribute variables);
β=└β┘=the model coefficients, i.e., the elasticities of each of the variables;
t=1,2,3 . . . T=the number of weeks;
Y=a measure of marketing effectiveness, such as brand metrics variables (e.g., awareness, favorability, consideration, etc.) or total brand sales. (Selection of this variable may depend on an advertiser's point of interest. In one embodiment, one of the actions of the modeling module 310 is optimizing the dependent variable, Y. To optimize sales, sales data, such as weekly/monthly sales figures obtained from a given advertiser, are used. For all other cases, the data are obtained from survey responses); and
ε=a stochastic error term.

The evaluation of advertising on a given media outlet can be specified by the following equation:

$${X}_{jt} = {α}_{0}^{′} + {\sum }_{t = 1}^{T} f {〈 ln ( {U}_{t} ) , ln ( {U}_{t - 1} ) 〉}^{{β}^{′}} + {ɛ}^{′} \qquad ( 2 )$$

where:
α′₀=the intercept;
Uₜ=└Uⱼₜ┘=an amount spent on advertising in media outlet j at time t;
β′=Model coefficients or media impact values; and
t=1,2,3 . . . T =the number of weeks.

In this embodiment, equation (2) assumes that survey respondents' evaluations of advertising on a given media outlet are functions of corresponding spending on advertising in that media outlet. The dependent variable Xⱼₜ is an independent variable of equation (1). This step combines data on media spending in a given outlet with survey data. The β′ coefficients of equation (2) provide the impact values for each media outlet. Finally, these impact values are combined with advertising reach data and advertising frequency data to adjust the media allocation recommendation. In one embodiment, the integration formulation is specified by equation (3):

Vⱼ=Rⱼ*Fⱼ*β′ⱼ (3)

where:
Vⱼ=the resources allocated to media outlet type j;
Rⱼ=the reach of media outlet j;
Fⱼ=the frequency of media outlet j; and
β′ⱼ=the media impact values (taken from equation (2)).

In one embodiment, demographic variables are used to establish a segment specific resource allocation strategy. These demographic variables, which may be obtained via surveys, may include age, stage of purchase need (e.g. 3, 6, 9, or 12 months until intended purchase), gender, income, household size, and ethnicity. A principal component analytic approach is used to identify the best segmentation variables. After segmenting the customer base by grouping the data according to the various values of the identified demographic segmentation variable, the above mentioned system of equations is applied within each of the segments to establish segment specific resource allocation strategies. For example, resource allocations may be determined separately for different ages (e.g. those aged 15-19, 20-24, 25-29, 30-34, etc.), for different levels of household income, and any other desired segments.

The above-described model is sufficiently broadly applicable to measure the effectiveness of a wide range of media in the absence or presence of data on total brand sales or spending on particular media outlets. For instance, in the absence of actual spending data, the sales or brand metrics (i.e., dependent variable on equation (1)) could be estimated solely as a function of media attribute combinations, i.e., the media-specific creative attribute variables described above. The omission of spending data would be part of the stochastic error term of equation (1). In the absence of reach and frequency data, the elasticities (i.e., coefficients of equation (1)) can be interpreted as individual and combinatorial media effectiveness on sales or brand metrics.

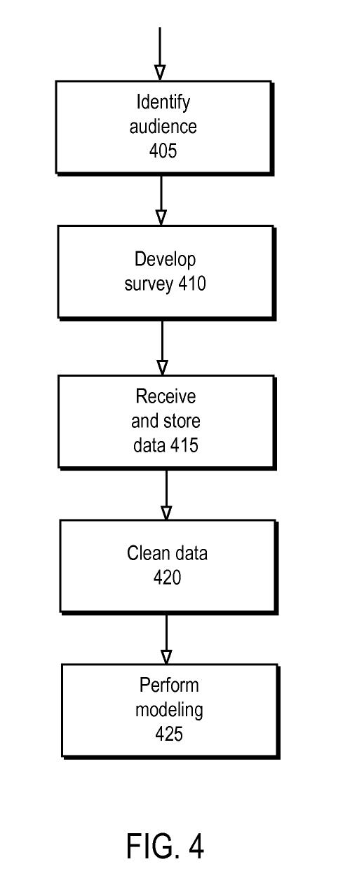

FIG. 4 is a flowchart illustrating an overall process of acquiring, processing, and presenting marketing information, which includes steps performed by the marketing analysis module in determining the output values 211 through 212 of FIG. 2, according to one embodiment.

First, a target audience is identified 405 based on desired target audience attributes. In one embodiment, the desired target audience attributes are provided by the advertiser and a target audience is manually selected by personnel associated with the organization controlling the marketing analysis system 115 based on the provided attributes.

Subsequently, a survey is developed 410 to capture consumers' opinions on various key brand metrics of interest, such as awareness of the brand, intent to purchase products or services associated with the brand, and/or any other appropriate brand metrics. In one embodiment, the survey is manually formulated by the personnel, possibly in cooperation with an advertiser, based at least in part on the provided attributes. The survey is then distributed for administration, e.g., by being provided in electronic form to an electronic publisher of advertisements for use as an online survey, or in printed form for administration in retail centers or other physical locations, for sending through the mail, and the like.

During the survey period, or at the conclusion thereof, the survey data generated by the surveys is received and stored 415 by the marketing analysis system 115. In one embodiment, some of the data is received via an application programming interface (API) provided by the marketing analysis system 115, such as a web services-based API. Any data not yet in electronic form, such as printed surveys, can be manually or automatically converted to electronic form and then stored along with the other electronic data.

The received data is then preprocessed 420 to filter out noise or unusable data, e.g. removing duplicate data, and to place the remaining data in a standardized format that the later analytical processes expect.

Once the received data has been properly prepared by the preprocessing step 420, mathematical modeling is then performed 425 to produce the set of output values that quantify the effect of actions in a particular advertising outlet on a particular measure of marketing effectiveness, as described more fully above with respect to FIG. 3.

With the output values of step 425 having been determined by the mathematical modeling, the output values are then made available to advertisers, e.g., via a web services API provided by the marketing analysis system 115 of FIG. 1.

Thus, the embodiments of the present invention provide effective ways to determine the effect of a particular type of media on a measure of marketing effectiveness, combining multiple distinct streams of data as input and taking into account the effects that advertising in different media outlets have on each other and on the overall marketing effectiveness result.

It is appreciated that although the example user interfaces discussed above were described as being generated by a web server and being executable in a web browser, the present invention is not so limited. Other embodiments can equally include alternate user interfaces that are known to those of skill in the art.

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely exemplary, and not mandatory; functions performed by a single system component may instead be performed by multiple components, and functions performed by multiple components may instead performed by a single component.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention could be embodied in software, firmware or hardware, and when embodied in software, could be downloaded to reside on and be operated from different platforms used by real time network operating systems. The present invention also relates to an apparatus for performing the operations herein. This apparatus may be specially constructed for the required purposes, or it may comprise a general-purpose computer selectively activated or reconfigured by a computer program executable by a processor and stored on a computer readable medium that can be accessed by the computer. Such a computer program may be stored in a computer readable storage medium, such as, but not limited to, any type of disk including floppy disks, optical disks, CD-ROMs, magnetic-optical disks, flash memory or disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability. The computers may communicate over local or wide area networks using wired or wireless network communication protocols.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A method for determining a resource allocation for a brand for each of a plurality of media outlet types, comprising:
receiving data that includes:
previous transactions corresponding to the brand,
individuals' attitudinal data about the brand, and
media exposure data for the brand for the plurality of media outlet types;
modeling a system of equations, wherein each equation describes a measure of marketing effectiveness for the brand as a sum of a plurality of marketing activities in a given media outlet type, each marketing activity weighted by a corresponding media impact value for the media outlet type;
determining the media impact values by applying a regression analysis and the received data to the system of equations; and
storing the determined media impact values in a computer storage medium.

2. The method of claim 1, further comprising determining a resource allocation for each media type of the plurality of media outlet types as a function of the media type's corresponding media impact value.

3. The method of claim 1, wherein the plurality of media outlet types comprise at least one of television, Internet, printed publications, and radio.

4. The method of claim 1, wherein the measure of marketing effectiveness is total sales for the brand.

5. The method of claim 1, wherein the measure of marketing effectiveness is one of awareness of the brand, opinion of the brand, and intent to purchase products or services associated with the brand.

6. The method of claim 1, wherein the received data further includes data describing previous resource allocation to the plurality of media output types for the brand.

7. The method of claim 1, further comprising:
identifying a demographic variable;
identifying a plurality of values of the demographic variable;
segmenting the received data according to the plurality of values of the demographic variable; and
performing the determining step for each of the identified plurality of values of the demographic variable using the associated subsets of the received data.

8. A marketing analysis system for determining a resource allocation for a brand for each of a plurality of media outlet types, comprising:
an information repository storing:
sales data corresponding to the brand,
survey data about the brand, and
media exposure data for the brand for the plurality of media outlet types; and
a modeling module configured to:
model a system of equations, wherein each equation describes a measure of marketing effectiveness for the brand as a sum of a plurality of marketing activities in a given media outlet type, each marketing activity weighted by a corresponding media impact value for the media outlet type, and
calculate the media impact values by applying a regression analysis and the received data to the system of equations.

9. The system of claim 8, wherein the modeling module is further configured to determine a resource allocation for each media type of the plurality of media outlet types as a function of the media type's corresponding media impact value.

10. The system of claim 8, wherein the plurality of media outlet types comprise at least one of television, Internet, printed publications, and radio.

11. The system of claim 8, wherein the measure of marketing effectiveness is total sales for the brand.

12. The system of claim 8, wherein the measure of marketing effectiveness is one of awareness of the brand, opinion of the brand, and intent to purchase products or services associated with the brand.

13. The system of claim 8, wherein the information repository further stores data describing previous resource allocation to the plurality of media output types for the brand.

14. The system of claim 8, the modeling module further configured to:
identify a demographic variable;
identify a plurality of values of the demographic variable;
segment the received data according to the plurality of values of the demographic variable; and
perform the calculating the media impact values for each of the identified plurality of values of the demographic variable using the associated subsets of the received data.
